(19) United States
(12) Patent Application Publication
(10) Pub. No.: US 2008/0183579 A1
(43) Pub. Date: Jul. 31, 2008

(54) System for originating and consummating sales and method

(76) Inventor: Correy B. Avner, Los Angeles, CA (US)

Correspondence Address: Daniel J. Meaney, Jr., Post Office Box 22307, Santa Barbara, CA, 93121, US

(21) Appl. No.: 12/008,562

(22) Filed: Jan. 11, 2008

Related U.S. Application Data
(60) Provisional application No. 60/897,582, filed on Jan. 26, 2007.

(51) Int. Cl. G06Q 30/00

(52) U.S. Cl. 705/14

(57) ABSTRACT

A system for originating and consummating sales of products using an online processor or manual operation is shown. The system includes an individual demonstrator for displaying a sponsored product, as opposed to an overt demonstration thereof, which attracts interest of a potential purchaser. A promotional and informational document is delivered to a potential purchaser which includes pricing data, ordering information, a website address for a potential purchaser to place an order and to enter instructions together with an identifying code assigned to the individual demonstrator. An online ordering and fulfillment processor enables a purchaser to originate a purchase of the sponsored product, accepts the entry by the purchaser of the identifying code, accounts for the sale and disburses payments therefor.

### CROSS-REFERENCES TO RELATED APPLICATIONS

This Application claims the benefit, under Title 35, United States Code §119(e), of U.S. Provisional Patent Application Ser. No. 60/897,582 filed Jan. 26, 2007.

### STATEMENT REGARDING FEDERALLY SPONSORED RESEARCH OR DEVELOPMENT

Not Applicable

### REFERENCE TO A “MICROFICHE APPENDIX” (SEE 37 CFR 1.96)

Not Applicable

### BACKGROUND OF THE INVENTION

1. Field of the Invention

The present invention relates to a system for originating and consummating sales. The system includes individual demonstrator for displaying, passively as opposed to overt demonstration activities, a sponsored product during normal personal activities in or outside of a designated area, which directly attracts the interest of other persons present in the area who may have an interest in purchasing a sponsored product. A promotional and informational document describing the product including pricing data is delivered to a potential purchaser expressing an interest in the sponsored product. A computer system having internet access to the world-wide web using the website address for communicating with an online ordering and fulfillment processor to enable a purchaser to originate a purchase of the sponsored product using the online ordering and fulfillment processor wherein the processor processed and fulfills the order including accepting the entry by the purchaser of the identifying code assigned to the individual demonstrator. The online ordering and fulfillment processor including an application program, a fulfillment program and a delivery program.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Description of the Prior Art

Online ordering and fulfillment systems for ordering products and delivering ordered products to a purchaser are known in the art.

At every moment of the day and night, information purveyors in effectively infinite number are striving to sell a product, service or other opportunity, solicit a donation or something else, enlist others for a cause or theology, and educate or persuade others. The variety of information content is consequently enormous and includes commercial, news, political, scientific, fine arts, religious, educational and charitable, among others. Consequently, the public is constantly subjected to an informational onslaught.

Compounding this onslaught is the sheer multitude of different avenues for disseminating information. Traditional avenues of information dissemination include, without limitation, print media, billboards, cable, television, radio and telemarketing. As below discussed, new avenues of information dissemination, such as the World Wide Web, not only compound the information purveying geometrically, but prompt the employment of extra layers of traditional information disseminators. As such, the Public is being drenched in an ever-expanding tidal wave of information in the ultimate constant pursuit of the minds and wallets of the Public. Against and providing natural resistance to all that, however, are peoples' natural limits of time, attention and tolerance to devote in their even attempting to differentiate amongst and within the massive streams of information ever-targeting them.

Accordingly, every serious disseminator of information must compete to overcome the natural limits of the available attention of their audience, often referred to the consumer or purchaser, in order to stand any chance of getting the consumer to favorably spend their resources with them, versus with others amongst the Universe of competing information disseminators.

Today's consumer is simply so inundated with massive quantities of information from a staggering array of sources, which are all vying to attract their personal attention, that the purveyors of information have created a state of unawareness as typically achieve the opposite of the intended result. Not surprising is that although, in the 1980's, consumers typically needed to be exposed to a conventional advertisement 3 to 5 times to engender in them a meaningful degree of recognition and recall of an intended message, consumers today understandably require more or a profoundly different exposure, precisely because of the overload caused by the great mass of information constantly bombarding them. While the advertising industry is only too happy to rise to the challenge by selling ever more conventional advertising largely un-tied to the intended result, that largely generates more over-saturation of the consumer with unsolicited information.

The result is an ever-escalating state of consumer numbing as has effectively disabled and de-motivated consumers from even trying to recognize and make the favorable consumer decisions so vigorously strived for by the myriad of competing information purveyors. The response, however, has been to escalate the information overload, including by information purveyors like traditional retail product and service providers rapidly augmenting their on-site, e.g. in-store presentations with additional sales channels, such as mail order and catalogues, which again further compounds the total informational overload on consumers.

At the same time, major technological advances have made it easier and less costly to use computer hardware and software to launch enterprises, and which has all but erased once formidable barriers to entering the ranks of purveyors of products, services and other promotional matter. Information publishing potentially in mass, is today well within the reach of most motivated new entrepreneurs and businesses. Consequently, ever more drastic means are employed by and on behalf of purveyors of goods, services and other information in their endeavoring to compete amidst the state of information over-load and over-abundance of options presented the consumer. The result of those concerted hyper-competitive efforts is that the consumers and purchasers, from their vantage point, understandably feel overwhelmed and naturally ignore if not resent and resist today's informational bombardment ever-targeting them in trying to gain their personal attention and comprehension.

Geometrically compounding that state of information overload, from and within competing traditional information mediums, is the Internet. While the internet has unquestionably provided profoundly greater accessibility to vastly more sources of goods and/or services available for resale, the internet's own information-escalating attributes have ironically caused its merchants and other information purveyors to take on expensive over-head standard for traditional businesses and once assumed readily bypassed via the e-commerce model.

Originally, the internet business and promotional models were viewed as vastly superior to traditional business and promotional models of purveying goods, services and other promotions, because the internet enabled its sponsor-promoters to bypass the most capital, time and attention intensive components traditionally required to launch any ostensibly viable operation as a purveyor of goods, services, charities, theology, news matter or other promotional agenda. Once assumed no longer at all needed under the internet e-commerce and e-promotional models (hereafter collectively the “e-model”).

While those resource requirements may have in the past been reliably bypassed by the “virtual store” and e-model, offering goods and services conceptually on a world-wide and “24-7” basis and without any physical store presence, the internet itself has drastically compounded the state of information overload. As such, while the internet has, at once, made information as to a multitude of sources of products and services, vastly more convenient to access (i.e. potentially accessible from any consumer's own internet connected computer terminal at any time of day or night), it has also greatly expanded the already vast number of disseminators of information and totality of information generated, all of which necessarily competing or the finite attention and interest of the consumer. There are literally tens if not hundreds of millions of internet sellers of goods and services all vying amongst themselves as well as with more traditional information disseminators to garner the attention and awareness of the already informationally-saturated minds of potential consumers, and further compounding their state of overload. Accordingly, in their quest to gain attention and visits to their sites, both store and internet purveyors of promotional information are increasingly reinstating significant overhead in the form of “pull through advertising.” Thus, internet purveyors are now buying print, broadcast and other media advertising in trying to draw consumers to their sites of commerce amidst the massive informational overload of the consumer-which inherently adds overload. Unfortunately, a vast number of information purveyors have not stopped with such largely expensive, ineffective, and in the aggregate, counter-productive activity.

Today, a myriad of purveyors are also endeavoring to capture the attention and wallets of the already informationally overloaded consumers, by a variety of not only ineffective, but also counter-productive, means. The internet has become literally plagued with virtual sensory assaults on potential consumers, by employing programs to target the consumers' computers en masse. Examples include distracting and annoying pop-ups, imbedded message bars and flashers, and the like.

Even more counterproductive is the proliferation in the use of insidious programs designed to effectively mass commandeer host computers. These computer glitching programs, by purposeful design, covertly attach themselves as automatic downloads via the potential consumers or potential purchasers unwittingly downloading of attractive sounding software giveaways (“lure ware”). Once both the free ware and piggy-backing disruptive software have been downloaded, the computer operation subsuming software is often further engineered to frustrate its thereafter being uninstalled. On attempted removal, the computer glitching program declines uninstallation, meeting the attempt with a message informing the computer owner that they must first uninstall the related lure ware that the consumer had typically impulsively downloaded. To further thwart uninstallation of the computer subsuming software, nowhere is the computer owner informed of the name given of the marginally desirable companion free ware that the disrupting software insists as having to first be uninstalled before the disrupting software will allow its uninstallation. And the companion programs typically are not even similarly named. Computer owners are thus subjected to prolonged periods where their “pirated”computers” are rendered largely inoperable by pop-up “offers,” permanent screen content obstructing presences, and the like. The computer owner is thus confronted with a lose/lose scenario and understandably not pleased with its cause. They must either (a) spend substantial time and/or resources in gamely trying to ferret out which software is the lure one that must be first uninstalled in order to extricate their computer from the grip of the insidious companion programs; (b) wipe out their entire computer memory by proceeding back to factory point restore setting; or (c) submit and acquire the computer pirating source's product or service relentlessly being “offered” whether or not needed, desired, or desirable and hope that the pirating software will then release its grip on their computer—although they often insidiously instead tighten. In the end, the “consumer” typically never gets real value or benefit from their compelled purchase, just their payment taken and accounts and computer exposed for further invasion. At best, the consumer must laboriously succeed at first ascertaining (and then uninstalling) the unidentified freeware, in order to be able to rid themselves, by thereafter uninstalling, the disruptive software. In addition to those tactics being, at minimum, unethical if not unlawful, Bad Will—not Good Will—is engendered. Their promoters therefore achieve the antithesis of what legitimate enterprises aspire to accomplish.

Other relatively more legitimate means are also being tried by information purveyors in their attempt, beyond sheer lowest price, to gain the attention and interest of the ever-more informationally barraged consumer. Those means, however, do not effectively meet the challenge as they are expensive and typically only marginally, at best, effective. They include internet purveyors purchasing temporary priority placement of their offering links on response pages of major search engines. Not only is that expensive, but the costs tend not to be reliably correlated to actual sales results achieved. Indeed, so amorphous and operationally haphazard is the operative relationship between search engines which charge fees for their page diversions of potential consumers on a charge-per-visit-hit basis, but a cost benefit determination cannot be reliably made. No wonder that internet page placement purchasers are now alleging in Court actions to having been tortiously victimized by “click fraud” committed by their competitors purposely running up their costs by insincerely accessing their sites en masse via visits through charge-per-click internet referring sources (see: The Wall Street Journal, Apr. 5, 2005, p. B 8: Internet Firms Face Legal Test on Advertising Fees). Also increasingly resorted to, and inherently unproductive, is the purchase of hard print, television and radio advertising to try to pull the consumer to their internet site—at great expense. Ironically, such endeavors, in addition to bringing back expensive overhead once thought wholly avoided by the e-model and not corresponding to actual results, themselves add to the total mass of information bombarding the consumer, making differentiation by the consumer from and amongst all available products, services and other promotional offerings, all the more difficult to perceive and over-all ineffective to achieve.

Internet e-commerce has thus become a victim of its own initially useful attributes, taking on the less productive and expensive attributes of the traditional business models. For example, as of March 2005, punching in the words: “jewelry AND design” on a major internet search engine, resulted in over 9,500,000 “matches” shown. Such over-proliferation of information disseminators all competing for consumer attention—both over the internet and otherwise has resulted in a revival by merchants, service providers and other information disseminating promoters, of resorting to very expensive, overhead increasing, and at best marginally effective, external marketing feeders central to traditional business models, although once thought fully by-passed under the e-commerce model. In their quest to compete, internet merchants now are pay dearly for print, radio, television and other media promotion of their web site, commonly known as “pull through advertising” trying to gain consumer attention in order to “pull” the consumer “through” to their internet site.

That expensive increase in overhead, however, is not the only challenge resulting from re-instituting expensive feeder marketing once thought obviated via the internet e-model. Traditional external feeder modes, e.g. newspaper advertising of web sites, inherently are of limited effectiveness at generating product and web site exposure, including since they must compete against, and thus tend to get lost amidst, the mass of other similar attention seeking/mind numbing “information offerings.” It's certainly no wonder that the potential consumer, potential purchaser or purchaser often ignores such matter, when perceived at all, or resents and thus resists its attempted message. Typically, those self-promotions are viewed as but more “junk mail” and similar unwelcome solicitations.

There thus is a need for purveyors of products, services and other promotional offerings operating via the internet and otherwise to be able to gain the attention of the consuming public, potential purchasers and purchasers on a cost and actual results relational basis, without incurring large fixed overhead costs not tied to actual results achieved nor tending to get lost amongst competing information presentations. To date, the prior art has not provided effective solutions. The present invention, however, does.

Methods and system for doing business using web services are also known in the art.

U.S. Pat. No. 6,792,605 discloses a method and apparatus for accessing and using the internet including services and applications from a number of sources and integrating the same into a customized application to form a web service. The web service architecture maintains a directory of services available to provide processing or services. A web service engine uses service drivers associated with each service to generate and run time model in response to a request. The system of the invention in U.S. Pat. No. 6,792,605 is comprised of web services directory and a web service engine. The web service directory is the database while the web services engine is the processor that handles the web services requests.

United State Patent Application Publication US2003/0158792 A1 discloses a system and method for finding and serving consumer-product information for consumers over the Internet. The system includes internet information service which store information pertaining to Universal Product Number, such as for example, a URC number pre-assigned to each consumer product registered with the system along with a list of Uniform Resources Locator (URLs) that point to the location of one or more information sources on the internet, e.g. World Wide Web Services, which are related to such registered consumer products. Upon entering the UPC number into the system using conventional internet browser programs, the menu of URLs associated with the entered UPC number is automatically displayed for use selection.

United State Patent Publication Application US2006/0224462 Al discloses an automated jewelry exchange. The automated jewelry exchange is in the form of a information processing system for facilitating jewelry transactions. The information processing system includes a first interface for receiving suppliers information relating to a plurality of items of jewelry available for purchase and components related to the items and a database for storing the information relating to items and related components. The information processing system includes a second interface for presenting to buyers the information relating to the plurality of items of jewelry and for receiving from buyers a selection of an item for purchase and a search engine for searching the database of information relating to an item of jewelry and related components. The information processing system further includes logic for presenting buyer information associated with components related to an item of jewelry and options on constructing a jewelry assembly comprising the item and components selected by the buyer.

None of the prior art anticipate, disclose, suggest or teach a system for originating and consummating sales comprising an individual demonstrator displaying a sponsored product during normal personal activities which directly attracts the interest of other persons present in the area who may have in interest in purchasing a sponsored product as a result of observing the individual demonstrator's displaying activities in the presence of potential purchasers with the sales interest being generated primarily by the displaying activities of the individual demonstrator. A promotional and informational document e.g. sponsored business cards, CD Rom, etc., describing or explaining the product have or may include pricing related data is delivered to a potential purchaser expressing an interest in the sponsored product as a result of the individual demonstrator displaying activities. The promotional and informational document including ordering information, a website address for a potential purchaser to place an order for a sponsored product and instructions for the purchaser to enter an identifying code as the demonstrator and/or document will reveal to receiving a discount or other consideration assigned to the individual demonstrator as the source of the purchaser's interest in the sponsored product.

### BRIEF SUMMARY OF THE INVENTION

The present invention seeks to overcome the problems of the prior art by providing a system for originating and consummating sales comprising an individual demonstrator displaying a sponsored product during normal personal activities which directly attracts the interest of other persons in view of the individual demonstrator who may have in interest in purchasing a sponsored product as a result of the individual demonstrator's displaying activities in the presence of potential purchasers with the sales interest being generated primarily by the displaying activities of the individual demonstrator;

In the preferred embodiment, the system for originating and consummating sales comprises an individual demonstrator displaying a sponsored product during normal personal activities which directly attracts the interest of other persons present in the area who may have in interest in purchasing a sponsored product as a result of the individual demonstrator's displaying activities in the presence of potential purchasers with the sales interest being generated primarily by the displaying activities of the individual demonstrator. A promotional and informational document, e.g. sponsored business cards, CD Rom etc., describing the sponsored product(s) may include pricing related data is delivered to a potential purchaser expressing an interest in the sponsored product as a result of the individual demonstrator displaying activities, said promotional and informational document including ordering information, a website address for a potential purchaser to place an order for a sponsored product and instructions for the purchaser to enter an identifying code to enable the purchaser to obtain a discount or offer another advantage which code is internal to the system assigned to the individual demonstrator as the source of the purchaser's interest in the sponsored product so as to credit a sales originated commission. The online ordering and fulfillment processor enables a purchaser to originate a purchase of the sponsored product using the online ordering and fulfillment processor wherein the processor processed and fulfills the order including accepting the entry by the purchaser of the identifying code assigned to the individual demonstrator.

The system may include the online order and fulfillment processor having a computer system having internet access to the world-wide web using the website address for communicating with an online ordering and fulfillment processor to enable a purchaser to originate a purchase of the sponsored product using the online ordering and fulfillment processor. The processor processes and fulfills the order including accepting the entry by the purchaser of the identifying code assigned to the individual demonstrator. The online ordering and fulfillment processor including an application program containing a database identifying the sponsored product displayed by the individual demonstrator. The application program includes a data entry section enabling a purchaser to order a sponsored produce, accepting a purchaser's order and delivery information, accepting the entry of an identifying code for an individual demonstrator and accepting a payment mode to consummate the purchase of a sponsored product. The processor includes a fulfillment program responsive to the information and data entered into the application program by a purchaser. The fulfillment program verifies that the sponsored product of interest is in inventory and, if so, to process the order by accepting the payment mode for the amount of purchase including applicable taxes, shipping and handling charges and issuing shipping instructions to ship the sponsored product in accordance with the delivery information in the application program and to track and credit a commission on the product final sale to the individual demonstrator's account subject of the identifying code entered by the purchaser. The processor includes a delivery program for controlling inventory that is responsive to the issued shipping instructions for shipping the sponsored product to the purchaser in accordance with the delivery information entered in the application program by the purchaser.

For purposes of this invention, the word “product” or “sponsored product” includes any product, service, offering of a service or other promotional, sales, marketing or income generating activities where sales are generated through potential purchasers or users purchasing the product, service or the like. The term “potential purchasers” or “purchasers” or “consumers” is intended to cover any persons who may have or has an interest in purchasing the product, sponsored product, service or other activity of interest.

In it broadest aspect a method and system for achieving and fulfilling sales and other informational promotions via methodically motivated and situated non promotional display of sponsored product and routing consumers or purchasers interest in purchasing the same through systemically integrated transactional sites.

### BRIEF SUMMARY OF THE INVENTION

The present invention seeks to overcome the problems of the prior art by providing a new, novel and unique system for originating and consummating sales comprising an individual demonstrator displaying a sponsored product during normal personal activities which directly attracts the interest of other persons present in view of the individual demonstrator who may have in interest in purchasing a sponsored product as a result of the individual demonstrator's displaying activities in the presence of potential purchasers with the sales interest being generated primarily by the displaying activities of the individual demonstrator.

This is important in that the individual demonstrator does not rely on traditional demonstrations or other overt promotional activities to attract the attention of a potential purchaser to a sponsored product. An important aspect of the present invention is the individual demonstrator displaying of a sponsored product is free from traditional demonstrations or other overt promotional activities normally used in promoting sales of products.

The sponsored product is displayed by the individual demonstrator by undertaking normal activities, e.g. shopping in a designated area, which may or may not include other sponsoring persons, e.g. a department store. The sponsored product is designed to have certain unique features and to present a vivid aesthetic appearance. One example of such a sponsored product is a unique necklace or hair pin. The displaying of the sponsored product results in a potential purchaser observing the sponsored product, e.g. a uniquely designed necklace or hair pin, and being instantly attracted to the sponsored product directly as a result of the unique features and vivid appearance thereof. Typically, a person who expresses such an interest generally approaches the individual demonstrator displaying the sponsored product and makes an inquiry, e.g. “Where did you get that beautiful necklace?” The individual demonstrator then verbally answers that question and then delivers to the potential purchaser a promotional and informational document identifying one or more of the following information, the sponsor's name, brand, product line and/or pricing related data deliverable to a potential purchaser expressing an interest in the sponsored product as a result of the individual demonstrator displaying activities. The promotional and informational document includes ordering information, a website address for a potential purchaser to place an order for a sponsored product and a code, as when operatively used, will garner then a discount or other consideration. The code is assigned internally in the system to credit the individual demonstrator as the source of the purchaser's interest and attended final purchase of the sponsored product.

If the potential purchaser has an interest in purchasing the sponsored product, that potential purchaser then uses an online ordering and fulfillment processor to originate a purchase of the sponsored product using the online ordering and fulfillment processor. The processor processes and fulfills the order including accepting the entry by the purchaser of the identifying code assigned to the individual demonstrator.

Therefore, it is an advantage of the present invention to provide a system for originating and consummating sales comprising an individual demonstrator displaying a sponsored product during normal personal activities which directly attracts the interest of other persons present in view of the individual demonstrator who may have an interest in purchasing a sponsored product as a result of the individual demonstrator's displaying activities in the presence of potential purchasers with the sales interest being generated primarily by the displaying activities of the individual demonstrator.

Another advantage of the present invention is that when a potential purchaser responds to the displayed device upon expressing an interest in the sponsored product as a result of the individual demonstrator displaying activities, the individual demonstrator delivers to the potential purchaser a promotional and informational document describing or identifying the product or product source.

Another advantage of the present invention is that when the individual demonstrator delivers to the potential a promotional and informational document, the promotional and informational document may include ordering information, the sponsor, brand or product line identification, a website address for a potential purchaser to place an order for a sponsored product and an identifying code which when operatively entered by a purchaser will afford then a discount or other consideration, and which demonstrator as the source of the purchaser's interest in the sponsored product.

Another advantage of the present invention is that when the individual demonstrator delivers to the potential purchaser a promotional and informational document, the purchaser then uses an online ordering and fulfillment processor to enable a purchaser to originate a purchase of the sponsored product using the online ordering and fulfillment processor wherein the processor processed and fulfills the order including accepting the entry by the purchaser of the identifying code assigned to the individual demonstrator.

Another advantage of the present invention is that the online order and fulfillment processor includes a computer system having internet access to the world-wide web using the website address for communicating with an online ordering and fulfillment processor to enable a purchaser to originate a purchase of the sponsored product using the online ordering and fulfillment processor wherein the processor processed and fulfills the order including accepting the entry by the purchaser of the identifying code assigned to the individual demonstrator.

Another advantage of the present invention is that the online order and fulfillment processor includes an application program containing a database identifying the sponsored product displayed by the individual demonstrator, a data entry section for accepting a purchaser's order and delivery information, a code processing section for accepting the entry of an identifying code for an individual demonstrator or sponsoring host of a designated area or locale and an order consummating processing section for accepting a payment mode to consummate the purchase of a sponsored product.

Another advantage of the present invention is that the online order and fulfillment processor includes a delivery program for controlling inventory that is responsive to the issued shipping instructions for shipping the sponsored product to the purchaser in accordance with the delivery information entered in the application program by the purchaser.

Another advantage of the present invention is that the payment mode for consummating the purchase is a credit card or equivalent (e.g. prepaid card) and the fulfillment program secures an approval from the credit card issuer to consummate the purchase of the sponsored product.

Another advantage of the present invention is that the individual demonstrators or sponsoring host of a designates area or locale are recruited, engaged and motivated by affording them with an opportunity to earn additional compensation from displaying of sponsored products to potential purchasers as assured and enabled by a methodically assigned and disseminated identifying code thereby eliminating any requirement for an individual demonstrator to undertake promotional activities independent of the individual demonstrator's normal activities including display of the sponsored product.

Another advantage of the present invention is that the individual demonstrators are recruited, engaged and motivated by affording the individual demonstrators with an opportunity to earn additional compensation from displaying of sponsored products to potential purchasers as assured and enabled by a methodically assigned and disseminated identifying code thereby attracting demonstrators who include those as would not typically accept employment as due societal considerations as sales people (e.g. not wanting to be viewed in the same category as the preverbal “used car sales man”).

Another advantage of the present invention is that the individual demonstrators and other sponsoring parties of designated areas hosting the displaying of sponsored products by individual demonstrators in the designated areas are recruited, engaged and motivated by providing individual demonstrators and other sponsoring parties with ongoing, periodic or on-request statements of their origination credit accruals for originating sales of sponsored products as a result of an individual demonstrator displaying the sponsored product in the designated areas and to enable the individual demonstrators and other sponsoring parties to have access to the online ordering and fulfillment processor for monitoring of the individual demonstrators and other sponsoring parties accrued credits or compensation entitlements per accruals generated and recorded through application and operation of the individually assigned identification code entered into the online order and fulfillment processor.

Another advantage of the present invention is that when a potential purchaser responds to the displayed device, the individual demonstrator delivers to the potential purchaser a promotional and informational document identifying and/or describing the sponsored and/or product(s), perhaps also pricing related data and a discount code deliverable to a potential purchaser expressing an interest in the sponsored product as a result of the individual demonstrator displaying activities. A manual processing means may be used to enable a purchaser to originate a purchase of the sponsored product wherein the processing means fulfills an order including accepting the entry by the purchaser of the identifying code assigned to the individual demonstrator.

### BRIEF DESCRIPTION OF THE DRAWING

The present invention will become more fully understood from the following detailed description of a preferred but non-limiting embodiment thereof, described in connection with the accompanying drawings, wherein:

FIG. 1 is a block diagram showing the interaction between an individual demonstrator and a potential purchaser and the delivery of a promotional brochure and identifying code to a potential purchaser;

FIG. 2 is a block diagram showing the components of the online order and fulfillment processor;

FIG. 3 is a block diagram of system architecture during operation;

FIG. 4 is a block diagram of primary sponsor-to-demonstrator interaction;

FIG. 5 is a block diagram of further derivative sponsor-to-demonstrator interactions;

FIG. 6 is a flow diagram of direct operations for practicing this invention; and

FIGS. 7(A) and 7(B) comprise a software flow diagram for system for originating and consummating sales and method.

### DETAILED DESCRIPTION OF THE INVENTION

### Background

The present invention cuts through the haze of consumer information overload, and over comes defenses arising in consumers, potential purchasers and purchaser from their being the target of unwanted apparent solicitations, to create attention and achieve product, service and site differentiation and resulting integrated sales and other transactions, including on an actual results to cost basis. It accomplishes this through a system that methodically exposes potential consumers to unconventionally attention attracting deployments of specially motivated, but primarily free of overt context demonstrations of sponsored products, services and other sponsored matter. Upon so gaining the attention of potential consumers by the methodically using of display techniques that are free of overt context demonstrations (hereafter collectively “overt demonstrations” or “overt Promotions”), the demonstrators then route the consumers/purchasers to systemically integrated internet and/or designated areas of display (the “designated areas”, e.g. department stores), such as may be sponsored by other sponsoring parties.

Those objectives are accomplished within the system through the present inventions creation and methodical application of an integrated origination-coding component referred to herein as an “identifying code”.

Typically, the demonstrator is an independent contractor of a sponsor or either an independent contractor or employee of a sponsoring host of a designated area or locale. An individual demonstrator is assigned a unique identifying code via which the individual demonstrators are compensation driven or systematically motivated to effectively communicate to or inform the potential purchaser and is schematically motivated to do so.

The codes correspond externally with each consumer/purchaser to whom the individual demonstrator has provided their identifying code. The identifying code enables the consumer/purchaser to receive a special discount off the regular price, a free gift or some other consideration. The purchaser must enter the identifying code when purchasing sponsored products or services or committing to other sponsored transactions to receive a discount or other consideration.

Examples of “other transactions” for illustration purposes may include, without limitation, the purchaser completing a charitable donation, or enrolling in an offered informational seminar or signing on as a medical study subject, and any other commitment of time, money or other resources.

The codes apply internally within the system process so as to methodically motivate the individual demonstrators or sponsoring host, due to their being credited with a commission upon a purchaser making a final purchase or other transactional commitment (herein sometimes referred to as “sale”) via the purchaser having been routed to the site of the sponsored product using the present invention.

The purchaser using an online order and fulfillment processor, typically accessed using an Internet browser using known computer system including modems, communication systems, carriers and other related system equipment and component, as are well known to those skilled in the art, commences the ordering process. Under alternative embodiments of this invention, the purchase may be commenced by the prospective purchaser in person or after direct contact with the sponsor. The process includes the purchaser entering the identifying code provided by the individual demonstrator.

Upon the purchaser entering the code and upon the application program accepting the identifying code, the purchaser then becomes entitled to a pre-designated purchase price discount, a gift or other consideration. The “sale” is credited as having originated with the respective individual demonstrator assigned the particular identifying code. The purchaser is inherently motivated to use the identifying code in order to easily gain an extra benefit, e.g. a purchase price discount, which, in turn, assures the individual demonstrator, or other sponsoring parties, as the case may be, to be credited and thus compensated as having originated the sale of the sponsored product.

The individual demonstrators can be further “incentivized” via the identifying code, such as for example and without limitation, by enabling additional payment entitlements to accrue to the individual demonstrators upon special sales targets/contest awards being met, as well as by individual demonstrators garnering recruiter's fees and over-rides from the originations by using, in effect, sub-individual demonstrators who are recruited and enrolled as individual demonstrators.

Under one embodiment, the present invention garners attention to its presentation of sponsored goods, services and other matter promoted by deployment of systematically motivated (sometimes collectively referred to herein as “sponsored products or “products”), and the methodically displaying of sponsored products free from overt promotions.

On the other hand, it is contemplated that individual demonstrators will also alternatively use known systems and equipment that utilize sensory equivalents to visual and/or audio displays, such as for examples displays being made by electronic screen monitors, visual systems and the like as thereby expose the purchasers to sponsored products. When a potential purchaser actually observes the individual demonstrator and/or sponsoring host of a designated area or locale displaying the product, the potential purchaser will mentally remember seeing the sponsored displayed product on the electronic screen monitors, visual systems and the like to be more inclined to make an inquiry to the individual demonstrator.

The demonstrations are based on displays that are free from overt demonstrations, such as a staged presentation or the like, because the presentations are neither announced nor are they effectively little more than the demonstrators wearing or doing something in the presence of others gathering for a separate purpose. The individual demonstrations display sponsored products under circumstances and at locations and times devoted primarily to other than demonstrations.

For very simple illustrative purpose, one of an infinite number of potential examples features an attractive young lady demonstrator wearing a beautiful and striking hair pin not announced as being for sale, but in fact being for sale, at a tavern during happy hour and acting solely as an independent contractor being paid a commission per origination of final sale or other transactional commitment for a sponsored product.

Under such circumstance, typically a potential purchaser curiosity and/or other self-satisfying desire naturally leads a potential purchaser to inquire where they perhaps may obtain that which has been favorably showcased in their presence, i.e. where, in this example, they may acquire the beautiful hair pin.

The individual demonstrator typically will respond to the inquiries by obviously searching (such as looking in their purse) for a card, coupon, or other physical embodiment of information to give to the potential purchaser that which is in essence a promotional brochure, such as for example a preprinted business card of the sponsor; but which typically will not include the name of the demonstrator nor otherwise overtly connecting the demonstrator to the sponsor, at least until the marketing phase where the product ordered/or sponsored have achieved prestige in the public acceptance. The promotional brochure describes the sponsored product including, without limitation, pricing related data deliverable to a potential purchaser expressing an interest in the sponsored product as a result of the individual demonstrator displaying activities. The promotional and informational document includes ordering information, a website address for a potential purchaser to place an order for a sponsored product and instructions for the purchaser to enter an identifying code to gain a discount as pre-assigned to the individual demonstrator and/or sponsoring host to effect their being credited as the source of the purchaser's interest in the sponsored product.

The promotional and informational document may or may not include a picture of the sponsored product, a price discount, free gift or other consideration upon their making an order or other sponsored transactional commitment.

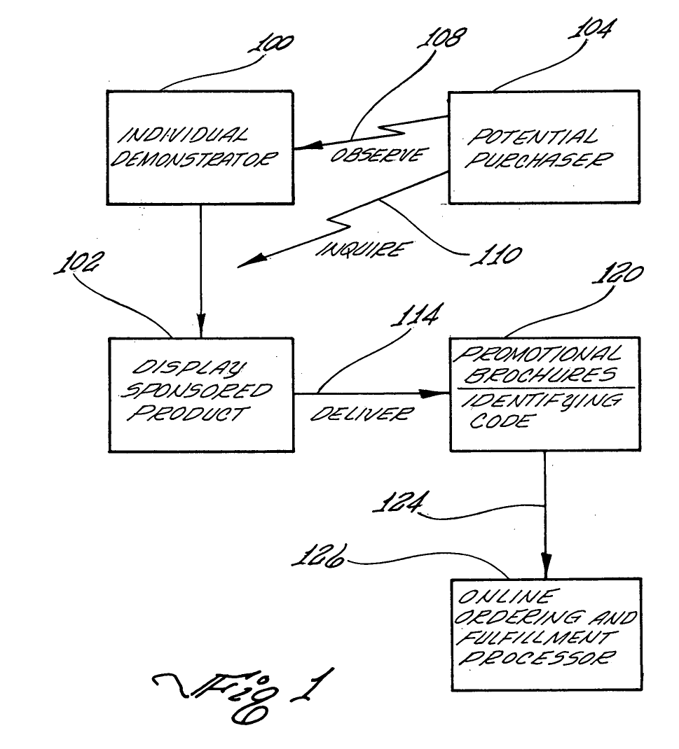

The interaction between an individual demonstrator and a potential purchase and the delivery of a promotional brochure and identifying code to a potential purchaser is shown by the block diagram of FIG. 1.

In FIG. 1, an individual demonstrator 100 elects to display for potential compensation a sponsored product, such as for example, a uniquely designed necklace or a hair accessory. The sponsored product could well be a service, such as a unique hair design performed by a hairdresser as a service. Thus, the term “sponsored product” is intended to cover any product, service or promotion and is represented by box 102.

The individual demonstrator 100 would display the sponsored product 102 during normal activities, e.g. in a school, at a beauty salon, while getting one's hair done etc, as opposed to providing overt demonstrations of a product at a fashion or cosmetic depart of a department store. Thus, the displaying activities are free of overt demonstrations and the displaying activities are performed in the ordinary course of living and including, but not limited to, in designated areas where potential purchasers would be present, e.g. in a shopping mall. The displaying can also be accomplished without the demonstrator being relegated to be taken as the stereotypical sales person.

A potential purchaser 104 would observe the displayed activity as depicted by arrow 108. If the potential purchaser has sufficient interest in the displayed sponsored product 102, e.g., thought the necklace was beautiful, typically such potential purchaser 104 would approach the individual demonstrator 100 and make an inquiry depicted by arrow 110, e.g. “Where did you get that beautiful necklace?”.

The individual demonstrator 100 would verbally reply to the potential purchaser 104 and during the discussion would present or deliver as depicted by arrow 114, a promotional and/or informational document (e.g. a business sized card) or other brochure 120 describing the displayed sponsored product 102 and may include including pricing, ordering information, a website address for a potential purchaser 104 to place an order for a sponsored product 102 and instructions for the purchaser 104 to enter an identifying code assigned to the individual demonstrator 100 will internally connect the individual demonstrator as the source of the purchaser's original interest through to final purchase of the sponsored product 102.

The potential purchaser 104 would then respond as depicted by arrow 124 to the promotional and/or informational document or brochure 120 by using an online ordering and fulfillment processor 126 to originate a purchase of the sponsored product 102. The online ordering and fulfillment processor 126 processes and fulfills the order including accepting the entry by the purchaser 104 of the identifying code assigned to the individual demonstrator 100.

Thus FIG. 1 discloses a system for originating and consummating sales of a sponsored product. The system comprises an individual demonstrator displaying a sponsored product during normal personal activities which directly attracts interest of a potential purchaser as a result of the individual demonstrator's displaying activities with the sales interest being generated primarily by the displaying activities of the individual demonstrator. A promotional and informational document describing the product is delivered to a potential purchaser expressing an interest in the sponsored product as a result of the individual demonstrator displaying activities. The promotional and informational document may include pricing data, ordering information and/or a website address for a potential purchaser to place an order for a sponsored product and along with an identifying code for the purchaser to operatively enter in order to obtain a discount which is coded or other consideration assigned internally within the system process to the individual demonstrator as the source of the purchaser's interest in the sponsored product. An online ordering and fulfillment processor enables a purchaser to originate a purchase of the sponsored product using the online ordering and fulfillment processor. The processor processes and fulfills an order including accepting the entry by the purchaser of the identifying code assigned to the individual demonstrator.

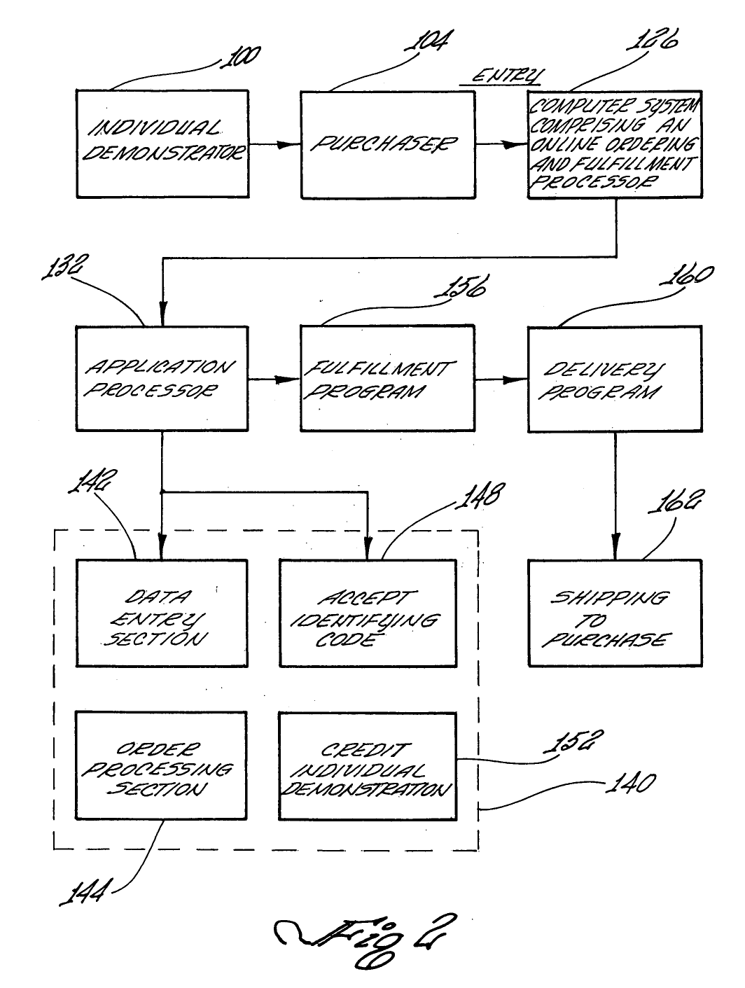

FIG. 2 is a block diagram showing the components of the online order and fulfillment processor 126. The online order and fulfillment processor 126 includes a computer system that is incorporated into the processor 126. The computer system has internet access to the world-wide web using the website address for communicating with an online ordering and fulfillment processor 126 to enable a purchaser 104 to originate a purchase of the sponsored product 102 using the online ordering and fulfillment processor 126. The processor 126 processes and fulfills the order including accepting the entry by the purchaser 104 of the identifying code assigned to the individual demonstrator.

The online ordering and fulfillment processor 126 includes an application program 132 containing a database 140 identifying the sponsored product displayed by the individual demonstrator 100. The application program 132 including a data entry section 142 enabling a purchaser to order a sponsored product, an order processing section 144 for accepting a purchaser's order and delivery information, code processing section 148 for accepting the entry of an identifying code for an individual demonstrator and an order consummating processing section 152 for accepting a payment mode to consummate the purchase of a sponsored product.

If the sponsored product is not in inventory, the fulfillment program communicates with the product production component and assembly source to generate the sponsored product for fulfillment.

The online order and fulfillment processor 126 includes a fulfillment program 156 that is responsive to the information and data entered into the application program 132 by a purchaser. The fulfillment program 156 verifies that the sponsored product of interest is in inventory and, if so, to process the order by accepting the, payment mode for the amount of purchase including applicable taxes, shipping and handling charges and issuing shipping instructions to ship the sponsored product in accordance with the delivery information in the application program 132 and to credit a commission on the product sale to the individual demonstrator's account and/or sponsoring host subject of the identifying code entered by the purchaser depicted by code processing section 148 for accepting the entry of an identifying code for an individual demonstrator and an order consummating processing section 152 for accepting a payment mode to consummate the purchase of a sponsored product.

The online order and fulfillment processor 126 includes a delivery program 160 for controlling inventory that is responsive to the issued shipping instructions for shipping the sponsored product to the purchaser 162 in accordance with the delivery information entered in the application program by the purchaser.

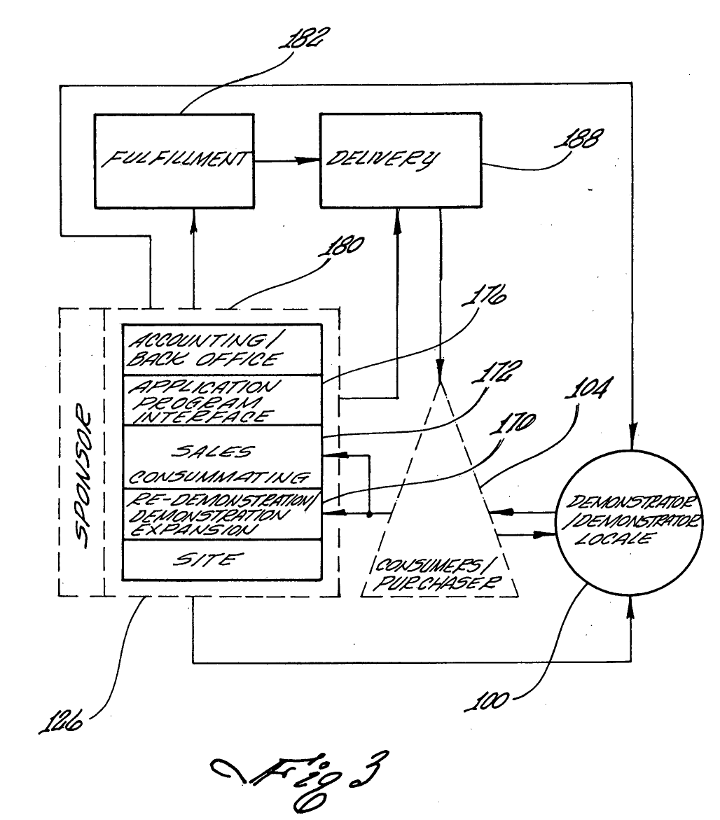

The ordering process using the online order and fulfillment processor 126 affords the consumer/purchaser the opportunity to input the identifying code so as to receive the then eligible discount or other special benefit on their making the purchase. The data and payment are processed, and then transmitted through an Application Program 132 to an Accounting/Back Office program shown in FIG. 3. The data is then sent by the online order and fulfillment processor 126 to the supplier/distributor for order fulfillment and in coordination with transporters (e.g. UPS) for delivery to the purchaser.

The transaction, upon becoming final, includes crediting the individual demonstrator 100, to whom the imputed identifying code was assigned, with a sales commission credit for having originated the sale as depicted by box 152 in FIG. 2. Also encompassed under one embodiment of the present invention are ultimately the determining of sales credit level achieving and/or periodic cutting of checks to pay the individual demonstrators or sponsoring host their entitlement of then aggregated origination commissions (or other pre-set consideration) accrued. Accounting data may also be generated for costs, revenues, profits, losses and taxes.

### Example of Identifying Code Assignment

In the preferred embodiment, there are several levels of parties who could participate in a sale of a sponsored displayed product. Level 1 would be the individual demonstrator. Level 2 would be a sub-individual demonstrator. Level 3 would be a sub-sub individual demonstrator. A Level2 sub-individual demonstrator could have a sub-sub-individual demonstrator. A party considered as an “other sponsor for a designated area” is considered a “sponsor” for purposes of assigning an identifying code.

The following is an example of assignment of identifying codes:

| Level 1 | Individual Demonstrator |
|---|---|
| Period | Code |
| I (1^{st} 6 months) | A1000.0 |
| II (2^{nd} 6 months) | A1000.1 |
| N (n^{th} 6 months) | A1000.n |

| | | Sub-sub |
|---|---|---|
| | #1 Sub-Individual | Individual |
| Level 2 | Demonstrator | Demonstrator |
| Period | Code | Code |
| I (1^{st} 6 months) | B1000.0 | B1000.0.1 |
| II (2^{nd} 6 months) | B1000.1 | B1000.1.1 |
| N (n^{th} 6 months) | B1000.n | B1000.n.1 |
| | | Sub-sub |
| | #2 Sub-Individual | Individual |
| Level 3 | Demonstrator | Demonstrator |
| Period | Code | Code |
| I (1^{st} 6 months) | C1000.0 | C1000.0.1 |
| II (2^{nd} 6 months) | C1000.1 | C1000.1.1 |
| N (n^{th} 6 months) | C1000.n | C1000.n.1 |

| Other Sponsor | Sponsor/Designated Area |
|---|---|
| Period | Code |
| I (1^{st} 6 months) | SDA1000.0 |
| II (2^{nd} 6 months) | SDA1000.1 |
| N (n^{th} 6 months) | SDA1000.n |

An affiliate system can be established in a computer system by assigning each affiliate a unique URL to direct traffic through to the sale. The affiliate system will track all visitors and affiliates involved in the sale through to the sale. Since each affiliate has a unique URL, the sponsor can report and/or view the amount/commissions each affiliate has earned. The affiliates can also login to their account at any time to view their statistics.

The above identifying codes are exemplary only and any known or potential coding system could be used as the identifying code. An alternative example may be the use of a catch code words such as “love I”, “boss E” etc.

With respect to the compensation to be paid to or accrued for the benefit of a person or party entitled to the same, software programs including programs having commission look-up tables could be used to attribute a programmed commission to a party by means of the assigned identifying code. The above is an example only and it is envisioned that any known coding systems, commission allocation programs and the like could be used within the teaching of the present invention to insure that programmed compensations, such as commissions, over-rides and the like, are attributed to the appropriate party entitled to the same based on the purchaser entering the identifying code into the online ordering and fulfillment processor.

It is also envisioned that individual demonstrators may use electronic monitor screens and/or audio transmitters situated by pre-arrangement with a party who is a sponsor of a designated area, without departing from the scope and spirit of the invention.

Also, other sponsoring parties, such as for example, a department store, may provide the individual demonstrators with cards, coupons, CD's or other physical embodiments of information stating the sponsor's site contacts as well as provide identifying codes created to identify a person who is a sponsoring party for a designated area. e.g. a department store.

In addition, an individual demonstrator may advise a potential purchaser that the use of the identifying code may enable the purchaser to receive (a pre-set) percentage price discount off the purchase price of the product, service or other promotion, or a free gift or other consideration.

FIG. 3 shows that the individual demonstrator 100 interacts with potential purchasers 104 by the displaying activities. The potential purchaser 104 then uses an online processing and fulfillment processor 126, which may be at a sponsor's site. The online processing and fulfillment processor 126 may perform one or more of the functions of re-demonstrating the sponsored product depicted by block 170, consummating the sale as depicted by block 172, use the application program as necessary to capture the entered data as depicted by block 176 and coordinate the back office activities depicted by block 180.

The final order processing is completed as depicted by block 182 and the sponsored product is delivered to the purchaser as depicted by block 188.

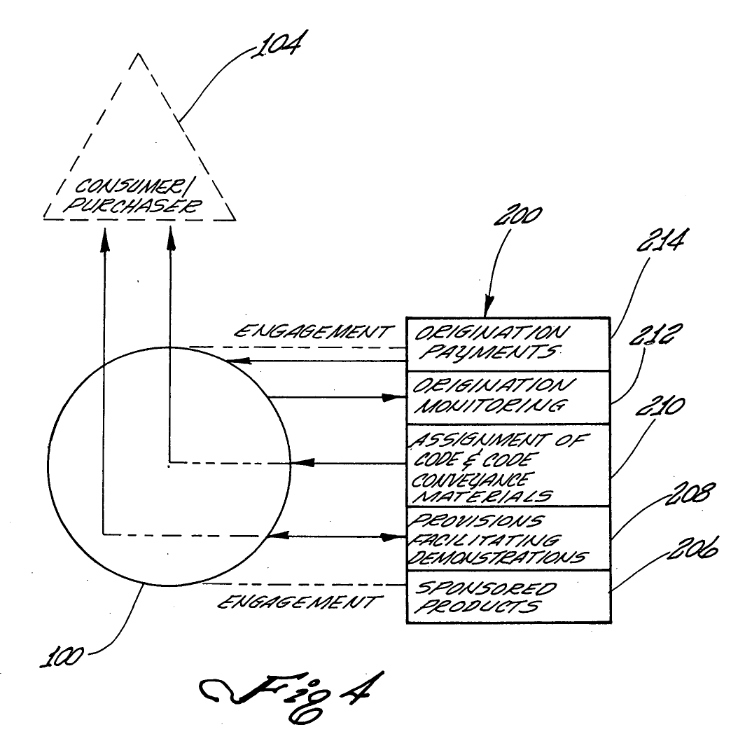

FIG. 4 shows the primary transactional interaction between a sponsor/sponsor site 200, on the one hand, and the individual demonstrator 100, on the other hand. The sponsor may provide the individual demonstrator 100 with exemplar samples of the sponsored product as depicted by box 206 and make provisions for making a designated area available for individual demonstrators to display the sponsored product as depicted by box 208.

The sponsor's site processor may assign the identifying codes as depicted by box 210, may undertake monitoring of activities as depicted by box 212 and finally make the commission payments as depicted by box 214.

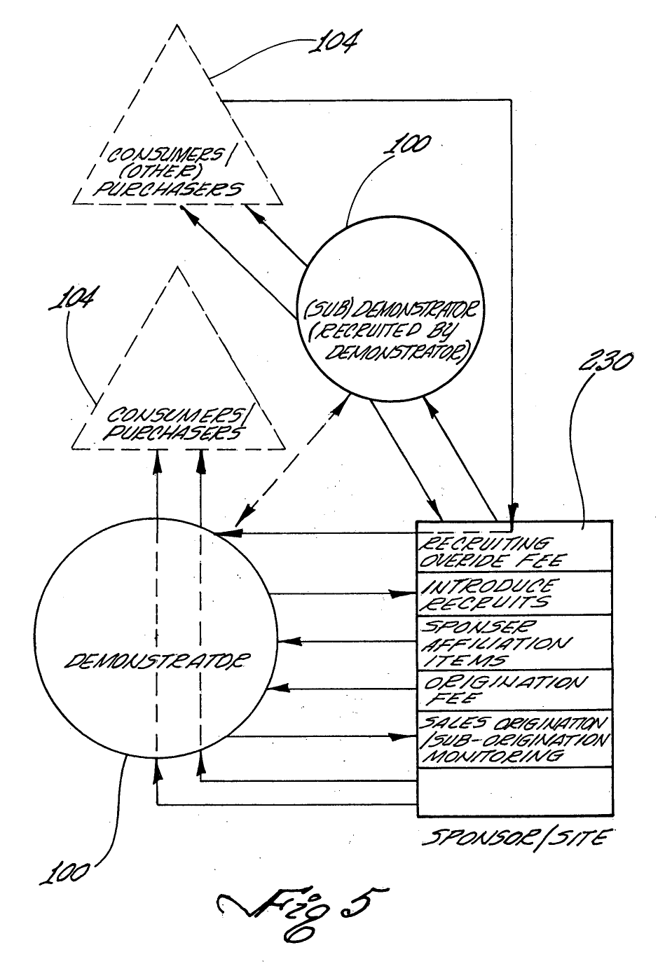

FIG. 5 depicts added layers of interaction between the sponsor and individual demonstrator 100 to illustrate further other incentive to be offered to the individual demonstrator, such as recruiting sub-demonstrators 100′, receiving credit over-rides for sales originations by another sub demonstrator who they recruited (and became sponsor enrolled) or sponsor involved incentives as depicted by 230.

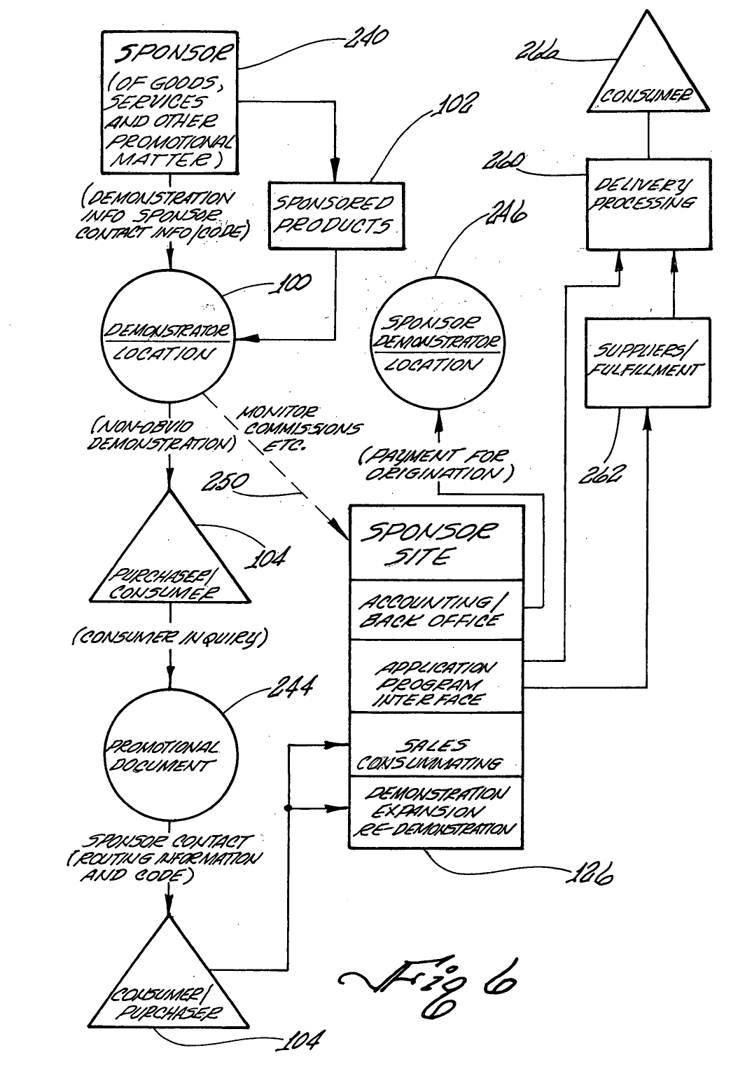

FIG. 6 is a flow diagram illustrating the operation of the present invention using the system illustrated in FIG. 1.

A sponsor 240 may use this invention to originate and complete sales of a sponsored product through individual demonstrators 100. In the preferred embodiment, the initial contact may be achieved by engaging an attractive female as an independent contractor functioning as the individual demonstrator 100 to display the sponsored product 102. These demonstrations may occur acting at such as, without limitation, happy hour taverns, restaurants, weddings, places of religious worship, place of employment or other vocation (e.g. college) or elsewhere.

The individual demonstrator 100 may decide to showcase the sponsored product by wearing it while waiting in line to make a mailing through the post office or in a long line waiting to see a popular movie. If the sponsored product is audio based, like music, a demonstrator may choose to play the music from a small CD player including inch-sized portable speakers. The number of applications is effectively unlimited, without departing from the intent, spirit or scope of the present invention. Typically, a potential purchaser having an interest in the displayed sponsored product 102 approaches the individual demonstrator 100 as depicted in FIG. 6 and makes an inquiry as discussed above.

The individual demonstrator 100 may respond with a thanks for the compliment and provides the potential purchaser with a promotional and informational document as depicted by circle 244, such as for example, an attractive card, coupon or other creative physical embodiments (e.g. CD rom that boots up the sponsor's selling web site).

The individual demonstrator 100 then points out the identifying code on the promotional documents 244 and mentions to the potential purchaser that the potential purchaser's use of identifying code may gain them a percentage discount (e.g. 5%) off the regular price, a free gift and/or other consideration (pre-set and stated at the sponsor site) just by their entering the identifying code in to the online ordering and fulfillment processor.

If a sponsor is involved, the identifying code will also internally identify the sponsor to insure that the sponsor as depicted by circle 246 receives an appropriate credit.

Item 126 includes an application program interface which insures that delivery processing, depicted by element 260, and the supplier's fulfillment, as depicted by element 262, function to deliver the sponsored product(s) to the consumer as depicted by element 266.

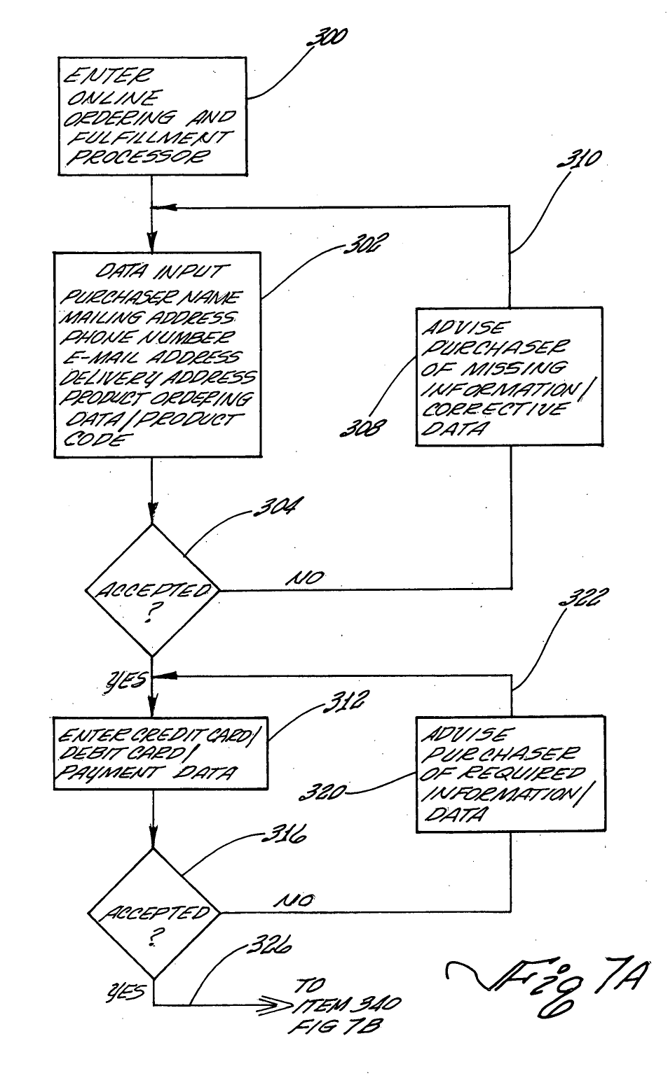

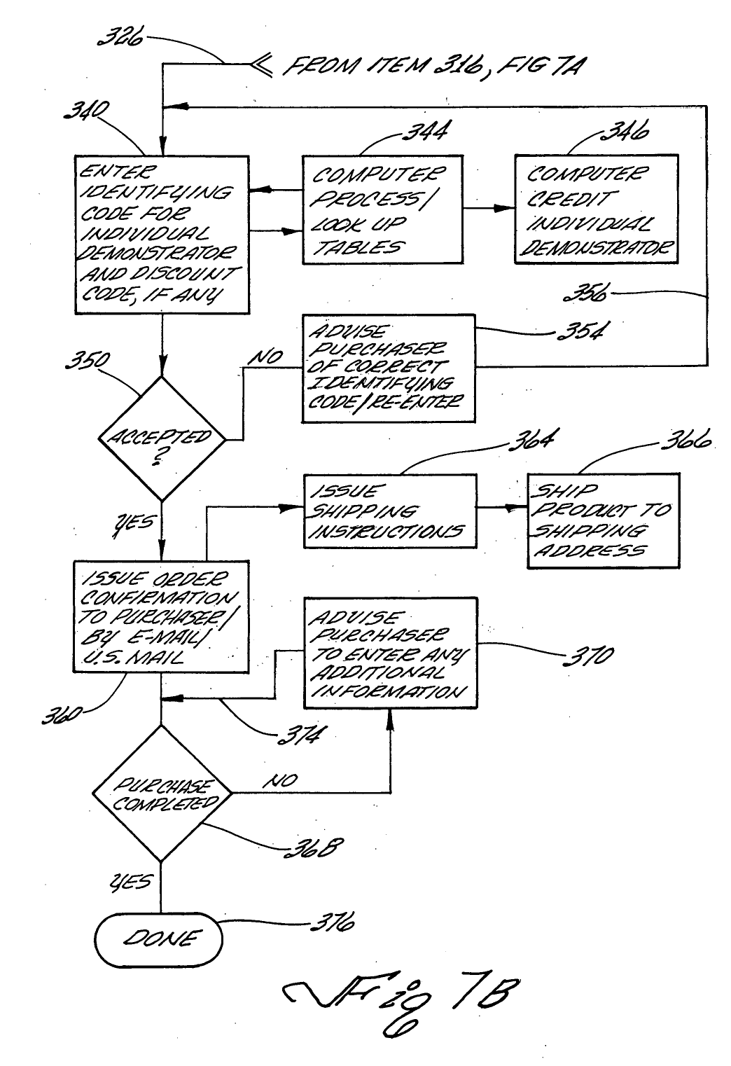

FIGS. 7A and 7B together comprise a software flow diagram for the system for originating and consummating sales and method.

When a potential purchase desires to place an order, the potential purchaser enters the online ordering and fulfillment processor depicted by element 300.

The purchase then provides the required data input in terms of purchaser's name, mailing address, phone number, e-mail address, delivery address product ordering data/product code, all as depicted by element 302.

The system then determines if the data input is accepted as depicted by element 304.

If the data input is found to be not acceptable as depicted by “No”, then the system advises the purchaser of the missing information and/or corrective data as depicted by element 308. This message or instruction is conveyed to the purchaser as depicted by line 310 and the purchaser then enters the required information.

If the data input is found to be acceptable as depicted by “yes shown on element 304, then the system progress to the instruct the purchaser to enter credit card/debit card or other payment data e.g. prepaid card as depicted by element 312.

If the payment data input is found to be not acceptable as depicted by “no” on element 316, then the system advises the purchaser of the required information/data as depicted by element 320. This message or instruction is conveyed to the purchaser as depicted by line 322 and the purchaser then enters the required information.

If the payment data input is found to be acceptable as depicted by “yes shown on element 316, then the system process the payment data and the results are conveyed to the system for further processing and use as depicted by line 326 in FIG. 7A.

Referring now to FIG. 7B, the payment data and the results are conveyed to the system for further processing and use appear on line 326 also appearing in FIG. 7B and the information is received by the system which then instructs the purchaser to enter the identifying code for the individual demonstrator and discount code, if any as depicted by element 340. The computer in the system receives and processes the identifying code and discount data by use of look-up tables or equivalent as depicted by element 344. The computer then credits the individual demonstrator and/or sponsoring host with the sale and with an appropriate commission as depicted by element 346.

If the identifying code and discount is found to be not acceptable as depicted by “no” on element 350, then the system advises the purchaser of the correct identifying code and re-enter instructions as depicted by element 354. This instruction is conveyed to the purchaser as depicted by line 356 and the purchaser then enters the required information.

If the identifying code and discount is found to be acceptable as depicted by “yes shown on element 350, then the system processes the order and issues an order confirmation to the purchaser by e-mail or by United States Mail as depicted by element 360.

The system then process the order and issues shipping instruction as depicted by element 364 and the sponsored product(s) are then shipped to the shipping address as depicted by element 366.

The final step of the process is to determine if the purchase has been completed as depicted by element 368.

If the purchase is found to not be completed as depicted by “no” on element 368, then the system advises the purchaser to enter any additional required information as depicted by element 354. This instruction is conveyed to the purchaser as depicted by line 370 and the purchaser then enters the required information as depicted by line 374.

If the purchase is found to be completed as depicted by “yes shown on element 368, then the system is done as depicted by element 376.

As a result of the above, this invention teaches and discloses a method for originating and consummating a sales comprising the steps of: (a) entering on an online ordering and fulfillment processor data input in terms of purchaser's name, mailing address, phone number, e-mail address, delivery address product ordering data/product code; (b) determining if the data input is accepted and if not accepted, then advising the purchaser of the missing information and/or corrective data to be entered and, if accepted, then instructing a purchaser to enter credit card/debit card or other payment data; (c) instructing the purchaser to enter an identifying code for an individual demonstrator albeit ostensibly a discount code, if any; (d) processing the identifying code and discount data by the use of look-up tables or equivalent and if the identifying code and discount is found to be not acceptable then advising a purchaser of the correct identifying code and instructing a purchaser to re-enter the required information, and if the identifying code and discount is found to be acceptable, then processing the order and issuing an order confirmation to the purchaser by e-mail or by United States Mail; (e) crediting an individual demonstrator with the sale and with an appropriate commission; and (f) processing the order and issuing shipping to ship the product to the shipping address.

The method may further comprise the step of processing the identifying code and discount data includes the use of look-up tables or equivalent to determine if the purchaser is entitled to other considerations such as an additional discount or gift.

The method may further comprise the step of crediting an individual demonstrator with the sale and with an appropriate commission includes determining if a sponsor is entitled a commission.

Within the spirit and intent of the present invention, purveyors of products, services and other promotional matter under traditional business model format (e.g. retail stores) can also benefit from using the present invention, with its non-obvious/out of context demonstrations and integrated code components, and which routes the consumer to the sponsor's on site location(s), e.g. a retail store location[s], rather than (or in addition) to routing the consumer to the sponsor's internet site). At the sponsor site, the customer is enabled to make the final purchase using the code provided them by the non-obvious demonstrator or out -of-context demonstration locale for a discount, free gift or other benefit. The demonstrator or location assigned that particular code in turn gets credited for the origination, with the equivalent of the back office accounting functions applicable under the e-commerce model using the present invention, being implemented via the “cash register” software upon the on-site (e.g. physical retail store site) cashier recording the code in charging the customer in transacting the sale.

An individual demonstrator may use the processor 126 to monitor commissions etc. as depicted by arrow 250

The site sponsor utilizing the instant invention, will define the extent of discount/gifts/consideration afforded to the (code receiving) customer and the extent of commission to be generated (to the code disseminating demonstrator), as, under one embodiment of the present invention, by pre-set and/or published limits by the number of uses of the code and/or the time duration allowed for a particular codes effective use. Allowable variations in the extent that the codes will be enabled to generate discounts/gifts/consideration (to the consumer), and/or commission entitlements (to the originating demonstrator assigned a code), are infinite. As decided by the sponsor, they may range from affording customers a discount/gift/other consideration for each and every purchase using the code without limitation, while also affording the code-corresponding demonstrator with an unlimited number of commission credits owed the originating demonstrator, to limiting each code to afford but a single item discount/gift/consideration to the customer and single commission due and owing the demonstrator, further limiting both of those to requiring that a final purchase (or other sponsored transaction) be made using the code within a very short time period (e.g. that day, few days, week, month) as pre-limited in its remaining effectiveness, such as, for example and without limitation, terminating their effectiveness through the system's software program default settings. The present invention also embodies every variation in between the possible extreme ranges of code-triggered entitlements, to the consumer or acquirer (e.g. price discount) and/or to the demonstrator (i.e. in their compensation credits for sales “origination”).

The assignment and operation of its codes, the information sponsors (e.g. such as the seller of the sponsored product are empowered to attract and motivate high caliber individual demonstrators and/or sponsoring host of a designated areas or locales due (a) the systematic assurance to the demonstrators, via the code system, of their getting credited and thus paid for the final sales of product (or service, etc) originated by them under this invention system and method, plus also affording them (and the sponsors) the opportunity to monitor and compare their relative origination performance and qualify for potential further awards (b) the methodical affording of the demonstrators with the opportunity to conduct their demonstrations in an effectively non-apparent manner, as well when and where determined by them, thus requiring minimal effort and with them retaining control over their personal zone of privacy and extent of interaction, and (c) without disruption of their principal avocations, so as to provide them additional earnings separate and beyond what they otherwise principally earn

Additional financial incentive options embodied under the present invention include, without limitation, paying an added fee, sales origination over-ride or other consideration to any enrolled demonstrator who introduces others accepted by their sponsor as an additional demonstrator and which recruited demonstrator then achieves target level transaction origination revenues.

As but one purely illustrative example, the individual demonstrator who introduces other potential individual demonstrators who become enrolled with their sponsor, may receive a $100.00 extra payment upon each individual demonstrator being recruited and enrolled, or $1,000.00 (or other pre-set target level) of resulting final sales or worth of other transactions, a percentage over-ride of the amount originated as a sales or other transactions, and effectively every variation thereof. Those final “sales” originations are also tracked and extra fee(s) accounted for (through to potentially cutting the additional payment checks and tax accounting and tax compliance form disbursals) such as by added digitizing of the “code” component explained above.

Available additional motivators under varying embodiments of the invention include, without limitation, providing a prize(s) to the individual demonstrator(s) who originates the most and/or meets a certain target(s), again tracked, accounted for and financially processed via the code component of the present invention. FIG. 2B illustrates the compensating interactions from the sponsor to the demonstrator from their recruiting of another demonstrator(s).

Identifying codes may be controlled by software to set specified time period (e.g. that day, month or quarter year) from their showing—to no expiration per passage of time, and every permutation in between.

The individual demonstrator may use the assigned identifying code to access a sponsor's internet, or in-store, computer tracking network and thereby monitor their own sales origination/credit generating performance, as well as how their level of originations compare to the credit performance of their sponsor's other also code-name denoted demonstrators via seeing their origination credits posted.

As a further embodiment of the present invention, under advanced marketing campaign phase, once public intrigue and a sense of brand desirability has been achieved in the sponsor's line of sponsored products through use of the present invention, sponsor may issue to their individual demonstrator(s), (such as those, without limitation, who've achieved a certain level(s) of sales origination results), special versions of sponsor identifying items (e.g. copyright protected apparel) to be enjoyed by the demonstrators, not sold (in identical form) to the public and bearing wording or insignia's to denote the select status of the demonstrators being sponsor affiliated, thereby furthering the recruiting of demonstrators and branding of select products, services or other promotions.

It is envisioned that the present invention may include the following features and elements.

The system can be programmed such that the payment mode for consummating the purchase is a credit card and the fulfillment program secures an approval from the credit card issuer to consummate the purchase of the sponsored product.

The individual demonstrators can be recruited, engaged and motivated by affording the individual demonstrators with an opportunity to earn additional compensation from displaying of sponsored products to potential purchasers as assured and enabled by a methodically assigned and disseminated identifying code thereby eliminating any requirement for an individual demonstrator to undertake promotional activities independent of the individual demonstrator's normal activities including display of the sponsored product.

The individual demonstrator's sales of sponsored products can be compensated by fees, commissions or other consideration entitlements which are credited as payable to individual demonstrator's display of sponsored products under a continuum comprised of one or more identifying codes assigned to each individual demonstrator. These identifying codes are disseminated to potential purchasers concurrent with the individual demonstrator's displaying activities to enable potential purchasers of sponsored goods to enter an identifying code into the online ordering and fulfillment processor at the time of entering an order. This would gain the purchaser's attention and inquiry and the identifying code would then be routed through the online ordering and fulfillment processor. The identifying code affords the potential purchaser certain discounts, gifts or other consideration upon the purchaser entering into the application program the identifying code when entering the order for a sponsored product through the online ordering and fulfillment processor so as to motivate the purchaser to enter the disseminated identifying code into the online processor or to present the identifying code from the promotional sponsored business card or brochure as had been provided to the purchaser by the individual demonstrator upon making a purchase thereby insuring that the individual demonstrator will receive an appropriate credit or commission and thus be compensated from or resulting final sale of a sponsored product.

The individual demonstrators may be recruited, engaged and motivated to make effective non-promotional demonstrations as displaying activities to gain potential purchaser's attention and then route the potential purchaser interest to the online ordering and fulfillment processor. This would methodically assure the individual demonstrator that when a purchaser order for a sponsored product using the online ordering and fulfillment processor is processed, that the individual demonstrator is credited for payment for the resulting final sale of sponsored product. This would be based on the potential purchaser being identified as the originator of the order via the purchaser entering the identifying code with the purchaser order.

The individual demonstrators and other sponsoring parties of designated areas hosting the displaying of sponsored products by individual demonstrators in the designated areas may be recruited, engaged and motivated by providing individual demonstrators and other sponsoring parties with ongoing, periodic or on-request statements of their origination credit accruals for originating sales of sponsored products as a result of an individual demonstrator displaying the sponsored product in the designated areas. This enables the individual demonstrators and other sponsoring parties to have a level of access to the online ordering and fulfillment processor for monitoring of the individual demonstrators and other sponsoring parties accrued credits or compensation entitlements per accruals generated and recorded through application and operation of the individually assigned identification code entered into the online order and fulfillment processor.

The individual demonstrators and other sponsoring parties may be recruited, engaged and motivated to earn additional compensation by affording individual demonstrators and other sponsoring parties the opportunity to recruit other sub individual demonstrators or designated areas. This would enable recruited individual demonstrators or other sponsoring parties securing additional designated areas for displaying sponsored product to be credited with an over-ride, fee, prize or other compensation upon the respective recruited individual demonstrators and other sponsoring parties achieving originations or target levels of originations of sales of sponsored product. These achievements would be tracked in the online ordering and fulfillment processor based on identifying codes entered into the online ordering and fulfillment processor by purchasers.

The individual demonstrators may be recruited, engaged and motivated to earn additional compensation beyond that generated by their own originations by enabling the individual demonstrators to recruit individual demonstrators and enter data identifying the recruited individual demonstrators into the online ordering and fulfillment processor. When the data has been accepted the online ordering and fulfillment processor may assign an identifying code to each recruited individual demonstrator to track the respective originations of the recruited individual's sales or originations of sponsored product via the assigned identifying code such that the recruiting individual demonstrators are compensated for appropriate sponsored product sales.

The designated areas used by an individual demonstrator at which potential purchasers congregate may include strategically placed electronic audiovisual monitors to enable the maximum number of potential purchasers to observe the display of sponsored product.

The other sponsoring parties having designated areas where potential purchasers congregate can be effectively recruited via systematically assuring the other sponsoring parties that they are being credited for payment for the origination of product sales in their designated areas.

The other sponsoring parties may be recruited and motivated to enable display of sponsored goods, services or other promotions to by electronic or other devices thereby supporting the displaying activities of the individual demonstrator. This affords the other sponsoring parties access to internal data of the online ordering and fulfillment processor so as to enable the other sponsoring parties to monitor compensation credits accruing for payment from final sales of sponsored products which credits accrue based on the identifying codes to insure that the other sponsoring parties receive an agreed compensation based on individual demonstrator displaying sponsored product at other sponsoring parties designated areas including data on sales target levels of sponsored products.

The individual demonstrators displaying activities may include an advanced marketing campaign phase for accelerating and or taking advantage of market branding resulting from potential purchasers intrigue through public adorations as to the sponsored products.

The present invention includes a method for originating and consummating sales of sponsored products. The method may comprise the steps of: (a) displaying by means of an individual demonstrator a sponsored product during normal personal activities which directly attracts interest of a potential purchaser as a result of the individual demonstrator's displaying activities with the sales interest being generated primarily by the displaying activities of the individual demonstrator; (b) delivering to a potential purchaser expressing an interest in the sponsored product as a result of the individual demonstrator displaying activities a promotional and informational document or equivalent describing the product wherein said promotional and informational document may include pricing data, ordering information, a website address for a potential purchaser to place an order for a sponsored product and an identifying code for the purchaser to enter assigned to the individual demonstrator as the source of the purchaser's interest in the sponsored product; and (c) enabling a purchaser to originate a purchase of a sponsored product using an online ordering and fulfillment processor wherein the processor processes and fulfills an order including accepting the entry by the purchaser of the identifying code assigned to the individual demonstrator.

The method may comprise the step of enabling a computer system having internet access to the world-wide web using the website address for communicating with an online ordering and fulfillment processor to enable a purchaser to originate a purchase of the sponsored product using the online ordering and fulfillment processor wherein the processor processed and fulfills the order including accepting the entry by the purchaser of the identifying code assigned to the individual demonstrator and wherein said online ordering and fulfillment processor includes an application program containing a database identifying the sponsored product displayed by the individual demonstrator, the application program including a data entry section enabling a purchaser to order a sponsored product, an order processing section for accepting a purchaser's order and delivery information, a code processing section for accepting the entry of an identifying code for an individual demonstrator and an order consummating processing section for accepting a payment mode to consummate the purchase of a sponsored product and applying a price discount or other consideration to the purchaser as applicable, a fulfillment program responsive to the information and data entered into the application program by a purchaser, said fulfillment program verifying that the sponsored product of interest is in inventory and, if so, to process the order by accepting the payment mode for the amount of purchase including applicable taxes, shipping and handling charges and issuing shipping instructions to ship the sponsored product in accordance with the delivery information in the application program and to credit a commission on the product sale to the individual demonstrator's account subject of the identifying code entered by the purchaser and a delivery program for controlling inventory that is responsive to the issued shipping instructions for shipping the sponsored product to the purchaser in accordance with the delivery information entered in the application program by the purchaser and from that on account by programming the system to generate and record resulting financial data and tax information as well as periodically generate checks for payment to the sponsored source of sales origination.

The method may comprise the step of enabling to include a payment mode for consummating the purchase being a credit card and the fulfillment program secures an approval from the credit and/or functionally equivalent card issuer to consummate the purchase of the sponsored product.

The method may comprise the step of displaying to include the individual demonstrators being recruited, engaged and motivated by affording the individual demonstrators with an opportunity to earn additional compensation from displaying of sponsored products to potential purchasers as assured and enabled by a methodically assigned and disseminated identifying code thereby eliminating any requirement for an individual demonstrator to undertake promotional activities independent of the individual demonstrator's normal activities including display of the sponsored product.

### Manual Implementation of System for Originating and Consummating Sales of Products

In a typical small business, sales are received by telephone, by mail or hand delivery.

In such businesses, a receiving clerk receives and processes the order and manually records receipt of the same in a manual system, such as, for example, on a ledger, sheet or sales recording system.

When the sale has been recorded, it is transmitted to an inventory-processing clerk to process the order. Most small businesses create their own inventory tracking system or they have had their accountant or CPA establish an appropriate inventory processing system. The system may include a tag system which can be used to produce periodic charts showing sales according to product line, brand or any other desired characteristic of a product, such as, for example, length, style and color.

The processing clerk would remove the ordered product from inventory and appropriately record the same. The processing clerk would then ship the product to the purchaser in accordance with the purchasing data received by the receiving clerk.

A manual product inventory tracking system provides the owner with important information, such as, what products are in stock, what product is on order, when ordered products are to be received and what product has been sold.

Typically, an owner pays sales commission on orders to sales people. In a manual sales system, the receiving clerk would record the purchaser's data including the name of any sales person who originated the sales including, if appropriate, an identification code of an individual demonstrator as described above. This data and information can be recorded manually in a ledger, sheet or manual bookkeeping system thereby manually tracking the source of the sales and the person or entity entitled to a sales commission thereon.

A bookkeeper or accountant can refer to a commission chart or commission schedule to identify the appropriate commission applicable to the sales of the product and credit the same to the appropriate person or entity.

A bookkeeper or accountant can then calculate the appropriate commission and manually prepare a commission check for the appropriate person or entity.

Affiliate systems are used by businesses to compensate people or sales persons for referring traffic and sales to the seller. In such event, the bookkeeper or accountant would establish an appropriate affiliate tracking system to identify each affiliate in the referring chain and to report and calculate the amount or commission due to each affiliate. Such affiliate system could have as many as five (5) levels each of which would have a separately assigned commission rate which compensates for one affiliate referring traffic or sales to another affiliate.

Using the above guidelines as to the state of the art in using manual systems generally described above, the system for originating and consummating sales of products may comprise an individual demonstrator displaying a sponsored product during personal activities of an individual demonstrator which directly attracts interest of a potential purchaser as a result of the individual demonstrator's displaying activities with the sales interest being generated primarily by the displaying activities of the individual demonstrator. A promotional and informational document describing the product is deliverable, by hand or otherwise, to a potential purchaser expressing an interest in the sponsored product as a result of the individual demonstrator displaying activities. The promotional and informational document includes pricing data, ordering information, and procedure for a potential purchaser to place an order for a sponsored product, such as for example, by phone or by written order. The potential purchaser is required to enter an identifying code assigned to the individual demonstrator instructions to be entered by the purchaser to receive a discount or other offered compensation as will be internally credited by the system as the demonstration source of the purchaser's interest to the ultimate final purchase of the sponsored product.

A manual processing means enables a purchaser to originate a purchase of the sponsored product wherein the manual processing means fulfills an order including accepting the entry by the purchaser of the identifying code assigned to the individual demonstrator.

The above system manual processing means may further comprise an order taker to receive and manually record the purchaser's data including identification of the sponsored product and the identifying code assigned to the individual demonstrator. An order processor responds to the manually recorded data identifying the sponsored product, removes the sponsored product from inventory, charges the purchaser for the sales price and applicable taxes for the sponsored product and ships the sponsored product to the purchaser.

The system manual processing means may further comprises a clerk to audit: (i) the manually recorded purchaser's data including identification of the sponsored product and the identifying code assigned to the individual demonstrator and confirm shipment; (ii) removal of the sponsored product from inventory; (iii) charging the purchaser for the sales price and applicable taxes for the sponsored product; and (iv) and shipping the sponsored product to the purchaser.

The system manual processing means may further comprise a Clerk responding to the manually record purchaser's data including identification of the sponsored product and the identifying code assigned to the individual demonstrator for calculating a commission due to the individual demonstrator using a commission rate assigned by the identifying code to the individual demonstrator.

There are many manual systems known in the art for recording, tracking and identifying sales activity. Manual systems including use of inventory tags and the like can be used for monitoring and controlling inventory. Accountants and bookkeepers can refer to look-up tables for assigned commission. Commission check can be manually prepared to pay the commissions due to the individual demonstrators.

It is envisioned that such known manual systems and the use of individuals to utilized the teachings of this invention using such known manual systems is within the teachings and scope of this invention.

Typically, the preferred embodiment is the use of a method and system requiring a computer implementation.

It is envisioned that the individual demonstrators may be selected or recruited using specific criteria such as, for example, an individual who is attractive or who presents a good presence or image that would be perceived as an individual who has personally selected sponsored products as opposed to a sales person, such as until the sponsor's brand recognition in the market place has been positively achieved. Responses to inquiries from potentially interested persons or potential purchasers can be typically handled in a casual manner by the individual demonstrator exhibiting a personal response to the inquiry of the potential purchaser, such as, without limitation, the demonstrator's exhibiting as being personally complemented by the potential purchaser's inquiry, i.e. “Thank you. That's nice of you to notice.”

The promotional brochure may be designed to contain specific information as described hereinabove. The promotional brochure may contain a logo or other indicia identifying a sponsor or other affiliate.

An individual demonstrator or other affiliate to whom a commission may be payable upon a potential purchaser purchasing a sponsored product, by entering the order using an on-line system or by communicating to a clerk in a manual ordering system, may have certain restrictions imposed as to when a commission is payable. For example, a commission could be payable for a designated period of time to the individual demonstrator, such as, for example, a six (6) month period. Other terms and conditions may be imposed for determining when a commission becomes an earned commission and when an earned commission becomes a payable commission.

It is also envisioned that a customer, after having purchased a sponsored product, may decide to reorder by re-accessing the on-line ordering system or by entering a new order using either computer-internet based or a manual sales system and such an order could be so entered without the purchaser being obligated to enter any identifying code. The sponsor of the sponsored product or other appropriate person controlling the ordering procedure could decide or program the on-line system or otherwise whether or not to honor any earlier granted discounts and/or sales origination commissions, if any.

In the preferred embodiment of the present invention, the potential purchaser is instructed to enter into the online ordering and fulfillment processor an identifying code assigned to an individual demonstrator or affiliate. However, it is envisioned that the system of the present invention could use an identifier other than an identifying code assigned to the individual demonstrator. For example, a password, URL code or the like could be used, or in the alternative, the system could be used by the potential purchaser without using any code at all with sales originations tracked territorially by geographic area or otherwise.

It will be appreciated that various alterations and modifications may be made to the system and methods for originating and consummating the sale of a sponsored or displayed product, service, promotion or the like to enhance the functional characteristics thereof. All such variations and modifications should be considered to fall within the scope of the invention as broadly hereinbefore described and as claimed hereafter.

All such uses, variations, modifications and the like of the teachings of this invention including the system and methods for enhancing sales of products, goods and services and promotions of all types are anticipated to be within the scope of this invention and encompassed interchangeably throughout by reference to “Products”.

What is claimed is:

1. A system for originating and consummating sales of products comprising
an individual demonstrator displaying a sponsored product during personal activities of an individual demonstrator which directly attracts interest of a potential purchaser as a result of the individual demonstrator's displaying activities with the sales interest being generated primarily by the displaying activities of the individual demonstrator;
a promotional and informational document describing the product deliverable to a potential purchaser expressing an interest in the sponsored product as a result of the individual demonstrator displaying activities, said promotional and informational document including pricing data, ordering information, a website address for a potential purchaser to place an order for a sponsored product and enter an identifying code assigned to the individual demonstrator or sponsoring host of a designatee area instructed to be entered by the purchaser and which by entry designates the source of the purchaser's interest in the sponsored product will be recorded; and
an online ordering and fulfillment processor to enable a purchaser to originate a purchase of the sponsored product using the online ordering and fulfillment processor wherein the processor processes and fulfills an order including accepting the entry by the purchaser of the identifying code assigned to the individual demonstrator Or to a sponsoring host of an area.

2. The system of claim 1 wherein the online order and fulfillment processor includes
a computer system having internet access to the world-wide web using the website address for communicating with an online ordering and fulfillment processor to enable a purchaser to originate a purchase of the sponsored product using the online ordering and fulfillment processor wherein the processor processes and fulfills the order including accepting the entry by the purchaser of the identifying code assigned to the individual demonstrator, said online ordering and fulfillment processor including
an application program containing a database including the sponsored product as has been displayed by the individual demonstrator, said application program including a data entry section enabling a purchaser to order a sponsored product, an order processing section for accepting a purchaser's order and delivery information, a code processing section for accepting the entry of an identifying code for an individual demonstrator and an order consummating processing section for accepting a payment mode to consummate the purchase of a sponsored product;
a fulfillment program responsive to the information and data entered into the application program by a purchaser, said fulfillment program verifying that the sponsored product of interest is in inventory and, if so, to process the order, and if not, to order the product and to accept the payment mode for the amount of purchase including applicable taxes, shipping and handling charges and issuing shipping instructions to ship the sponsored product in accordance with the delivery information in the application program and to credit a commission on the product sale to the individual demonstrator's account subject of the identifying code entered by the purchaser; and
a delivery program for controlling inventory that is responsive to the issued shipping instructions for shipping the sponsored product to the purchaser in accordance with the delivery information entered in the application program by the purchaser.

3. The system of claim 2 wherein the payment mode for consummating the purchase is a credit card, debit card or equivalent and the fulfillment program secures an approval from the credit card issuer or debit the account holder, as the case maybe, to consummate the purchase of the sponsored product.

4. The system of claim 3 wherein the individual demonstrators are recruited, engaged and motivated by affording the individual demonstrators with an opportunity to earn additional compensation from displaying of sponsored products to potential purchasers as assured and enabled by a methodically assigned and disseminated identifying code thereby eliminating any requirement for an individual demonstrator to undertake promotional activities independent of the individual demonstrator's normal activities including display of the sponsored product.

5. The system of claim 1 wherein individual demonstrator's sales of sponsored products are compensated by fees, commissions or other consideration entitlements which are credited as payable to individual demonstrator's display of sponsored products thereby gaining the purchaser's attention and inquiry under a continuum comprised of one or more identifying codes assigned to each individual demonstrator and disseminated to potential purchasers concurrent with the individual demonstrator's displaying activities to enable potential purchasers of sponsored goods to enter an identifying code into the online ordering and fulfillment processor at the time of entering an order and then routing the identifying code through the online ordering and fulfillment processor which identifying code affords the potential purchaser certain discounts, gifts or other consideration upon the purchaser entering into the application program the identifying code when entering the order for a sponsored product through the online ordering and fulfillment processor so as to motivate the purchaser to enter the disseminated identifying code into the online processor upon making a purchase thereby thereby insuring that the individual demonstrator or sponsor host will receive an appropriate credit or commission and thus be compensated from sale of a sponsored product.

6. The system of claim 1 wherein individual demonstrators are recruited, engaged and motivated to make effective non-promotional demonstrations as displaying activities to gain potential purchaser's attention and then route the potential purchaser interest to the online ordering and fulfillment processor thereby methodically assuring the individual demonstrator that when a purchaser orders a sponsored product using the online ordering and fulfillment processor that the individual demonstrator is credited and paid for the sale of sponsored products based on the individual demonstrator or sponsoring host being identified as the originator of the order based upon the purchaser entering the identifying code with the purchaser order.

7. The system of claim 5 wherein individual demonstrators and other sponsoring parties of designated areas hosting the displaying of sponsored products by individual demonstrators in the designated areas are recruited, engaged and motivated by providing individual demonstrators and other sponsoring parties with ongoing, periodic or on-request statements of their origination credit accruals for originating sales of sponsored products as a result of an individual demonstrator displaying the sponsored product in the designated areas and to enable the individual demonstrators and other sponsoring parties to have access to the online ordering and fulfillment processor for monitoring of the individual demonstrators and other sponsoring parties accrued credits or compensation entitlements per accruals generated and recorded through application and operation of the individually assigned identification code entered into the online order and fulfillment processor.

8. The system of claim 7 wherein individual demonstrators and other sponsoring parties are recruited, engaged and motivated to earn additional compensation by affording individual demonstrators and other sponsoring parties the opportunity to recruit other demonstrators or designated areas and to enable recruited individual demonstrators or other sponsoring parties securing additional designated areas for displaying sponsored product to be credited with an over-ride, fee, prize or other compensation upon the respective recruited individual demonstrators and other sponsoring parties achieving originations or target levels of originations of sales of sponsored product as tracked in the online ordering and fulfillment processor based on identifying codes entered into the online ordering and fulfillment processor by purchasers.

9. The system of claim 6 wherein individual demonstrators are recruited, engaged and motivated to earn additional compensation beyond that generated by their own originations by enabling the individual demonstrators to recruit individual demonstrators and enter data identifying the recruited individual demonstrators into the online ordering and fulfillment processor and when the data has been accepted the online ordering and fulfillment processor assigns an identifying code to each recruited individual demonstrator to track the respective originations of the recruited individual or sponsoring host sales of sponsored product via the assigned identifying code such that the recruited individual demonstrators or sponsoring host are compensated for appropriate sponsored product sales.

10. The system of claim 7 wherein designated areas at which potential purchasers congregate include strategically placed electronic monitors to enable the maximum number of potential purchasers to observe the display of sponsored product.

11. The system of claim 9 wherein other sponsoring parties having designated areas where potential purchasers congregate are effectively recruited via systematically assuring the other sponsoring parties that they are being credited for payment for the origination of product sales in their designated areas.

12. The system of claim 11 where other sponsoring parties are recruited and motivated to enable display of sponsored goods, services or other promotions to by electronic or other devices thereby originating interest in the sponsored product through to sales or supporting the displaying activities of the individual demonstrator and affording the other sponsoring parties access to internal data of the online ordering and fulfillment processor so as to enable the other sponsoring parties to monitor compensation credits accruing for payment from sales of sponsored products which credits accrue based on the identifying codes to insure that the other sponsoring parties receive an agreed compensation based on individual demonstrator displaying sponsored product at other sponsoring parties designated areas including data on sales target levels of sponsored products.

13. The system of claim 6 wherein the individual demonstrators displaying activities include an advanced marketing campaign phase for accelerating market branding resulting from potential purchasers intrigue as to the sponsored products.

14. A method for originating and consummating sales of sponsored products comprising the steps of displaying by means of an individual demonstrator a sponsored product during normal personal activities which directly attracts interest of a potential purchaser as a result of the individual demonstrator's displaying activities with the sales interest being generated primarily by the displaying activities of the individual demonstrator;
delivering to a potential purchaser expressing an interest in the sponsored product as a result of the individual demonstrator displaying activities a promotional and informational document describing the product wherein said promotional and informational document includes pricing data, ordering information, and procedure for a potential purchaser to place an order for a sponsored product and a requirement that the purchaser enter an identifying code for the purchaser to potentially receive a discount or the consideration upon completion of purchase which has been assigned to the individual demonstrator as the originator of the purchaser's interest in the sponsored product; and
enabling a purchaser to originate a purchase of a sponsored product using an online ordering and fulfillment processor wherein the processor processes and fulfills an order including accepting the entry by the purchaser of the identifying code assigned to the individual demonstrator.

15. The method of claim 14 where in the step of enabling includes
a computer system having internet access to the world-wide web using the website address for communicating with an online ordering and fulfillment processor to enable a purchaser to originate a purchase of the sponsored product using the online ordering and fulfillment processor wherein the processor processes and fulfills the order including accepting the entry by the purchaser of the identifying code assigned to the individual demonstrator and wherein said online ordering and fulfillment processor includes an application program containing a database identifying the sponsored product displayed by the individual demonstrator, said application program including a data entry section enabling a purchaser to order a sponsored product, an order processing section for accepting a purchaser's order and delivery information, a code processing section for accepting the entry of an identifying code for an individual demonstrator or sponsoring host of a designated area and an order consummating processing section for accepting a payment mode to consummate the purchase of a sponsored product, a fulfillment program responsive to the information and data entered into the application program by a purchaser, said fulfillment program verifying that the sponsored product of interest is in inventory and, if so, to process the order, and if not to order the product, and to accept the payment mode for the amount of purchase including applicable taxes, shipping and handling charges and issuing shipping instructions to ship the sponsored product in accordance with the delivery information in the application program and to credit a commission on the product sale to the account for the individual demonstrator or sponsoring host of a designated area related to the identifying code entered by the purchaser and a delivery program for controlling inventory that is responsive to the issued shipping instructions for shipping the sponsored product to the purchaser in accordance with the delivery information entered in the application program by the purchaser.

16. The method of claim 14 wherein the step of enabling includes the payment mode for consummating the purchase being a credit card, debit card or equivalent payment source and the fulfillment program secures an approval from the credit card issuer, debit card holder or issuer of the equivalent payment source to consummate the purchase of the sponsored product.

17. The method of claim 14 wherein the step of displaying includes the individual demonstrators or sponsoring host at a designated area being recruited, engaged and motivated by affording them with an opportunity to earn additional compensation from displaying of sponsored products to potential purchasers as assured and enabled by a methodically assigned and disseminated identifying code thereby eliminating any requirement for an individual demonstrator to undertake promotional activities independent of the individual demonstrator's normal activities including display of the sponsored product.

18. A system for originating and consummating sales of products comprising
an individual demonstrator displaying a sponsored product during personal activities on an individual demonstrator which directly attracts interest of a potential purchaser as a result of the individual demonstrator's displaying activities with the sales interest being generated primarily by the displaying activities of the individual demonstrator;
a promotional and informational document describing the product deliverable to a potential purchaser expressing an interest in the sponsored product as a result of the displaying activities of an individual demonstrator or sponsoring host of a designated area activities, said promotional and informational document including pricing data, ordering information, a website address for a potential purchaser to place an order for a sponsored product and enter an identifying code assigned to the individual demonstrator or sponsoring host of a designated area instructed to be entered by the purchaser so as to record the source of the purchaser's interest in the sponsored product; and
a manual processing means enabling a purchaser to originate a purchase of the sponsored product wherein the processing means fulfills an order including accepting the entry by the purchaser of the identifying code assigned to the individual demonstrator or sponsoring host of a designated area.

19. The system of claim 18 wherein the processing means comprises:
a order taker to receive and manually record purchaser's data including identification of the sponsored product and the identifying code assigned to the individual demonstrator or sponsoring host of a designated area;
an order processor for responding to the manually recorded data identifying the sponsored product, removing the sponsored product from inventory, charging the purchaser for the sales price and applicable taxes for the sponsored product and shipping the sponsored product to the purchaser.

20. The system of claim 19 wherein the processing means comprises:
a clerk to audit: (i) the manually record purchaser's data including identification of the sponsored product and the identifying code assigned to the individual demonstrator and confirm shipment; (ii) removal of the sponsored product from inventory; (iii) charging the purchaser for the sales price and applicable taxes for the sponsored product; and (iv) and shipping the sponsored product to the purchaser.

21. The system of claim 19 wherein the processing means comprises:
a clerk responding to the manually record purchaser's data including identification of the sponsored product or sponsoring host of a designated area and the identifying code assigned to the individual demonstrator for calculating a commission due to the individual demonstrator using a commission rate assigned by the identifying code to the individual demonstrator or sponsoring host of a designated area.

22. A method for originating and consummating a sales comprising the steps of:
entering on an online ordering and fulfillment processor data input in terms of purchaser's name, mailing address, phone number, e-mail address, delivery address product ordering data/product code;
determining if the data input is accepted and if not accepted, then advising the purchaser of the missing information and/or corrective data to be entered and, if accepted, then instructing a purchaser to enter credit card/debit card or other payment data;
instructing the purchaser to enter an identifying code for an individual demonstrator or sponsoring host of a designated area and discount code, if any;
processing the identifying code and discount data by the use of look-up tables or equivalent and if the identifying code and discount is found to be not acceptable then advising a purchaser of the correct identifying code and instructing a purchaser to re-enter the required information, and if the identifying code and discount is found to be acceptable, then processing the order and issuing an order confirmation to the purchaser by e-mail or by United States Mail;
crediting an individual demonstrator or sponsoring host of a designated area with the sale and with an appropriate commission; and
processing the order and issuing shipping to ship the product to the shipping address.

23. The method of claim 22 wherein the step of processing the identifying code and discount data includes the use of look-up tables or equivalent to determine if the purchaser is entitled to other considerations such as an additional discount or gift.

24. The method of claim 22 wherein the step of crediting an individual demonstrator or sponsoring host of a designated area with the sale and with an appropriate commission includes determining if a sponsor is entitled a commission.
